(19) United States
(12) Patent Application Publication
(10) Pub. No.: US 2003/0027453 A1
(43) Pub. Date: Feb. 6, 2003

(54) Structure of a coaxial cable connector (SMA)

(76) Inventor: Chih-Chuan Yeh, Taipei City (TW)

Correspondence Address: Chih-Chuan Yeh, P.O. Box 82-144, Taipei, TW

(21) Appl. No.: 09/920,656

(22) Filed: Aug. 3, 2001

(51) Int. Cl. H01R 9/05

(52) U.S. Cl. 439/578

(57) ABSTRACT

The invention is directed to an improved structure of a coaxial cable connector (SMA). Particularly, the expansion portion of a T-type connector has a hindering ring around it and a ring groove, in which the expansion portion of the T-type connector is fitting with a ring sleeve body with hollow inside. An imbedded protruding ring-hindering block with a 90° right angle exists on the inner wall of the ring sleeve body at the proper place. Using the ring-hindering block, the ring sleeve body can be affixed on a holding ring at the top ring rim of the expansion portion for the T-type connector. Moreover, a plate portion at the front end is pressed into an indent portion of inner wall of the ring groove on the T-type connector at the expansion portion.

### BACKGROUND OF THE INVENTION

(a) Field of the Invention

The present invention is to provide an improved structure of coaxial cable connector.

(b) Description of the Prior Art

As the great progress in modern civilization, information industry nowadays has played essential role in the current industries. It is expected to be a century of information for the 21st century. In our daily life for eating, clothing, living, transportation, education, and amusement, products of information surrounds us. Types of current information products are various, and almost all of the information products usually utilize cable to transport signals. Therefore, a connector used for connecting power line to the information products has played a significant role. In order to cohere with various products of information, various connectors have been developed. Usually, it is naturally to separate connectors into male connectors and female connectors. These connectors are using for assembling, so as to reduce the fabrication cost and enhance competition power. Therefore, the current connector in fabrication is under developing with a goal along the trend of low fabrication cost and fast working. Just as what has shown in the FIG. 1, it is a structure of conventional SMA connector 1. Particularly, it includes a T-type connector 11 and a sleeve ring 12′, which are assembled together. Due to the sleeve ring 12′, the plate portion 122′ at the front end is pressed in surrounding manner on the T-type connector 11′, within a ring groove 113′ of the expansion portion 111′ but the plate portion 122′ at the front end of the sleeve ring 12′ has an angle of 45°, enclosing the T-type connector 11 within the ring groove 113′. Therefore, when the connector (SMA) 1 is under a twisted and pulling test from the good testing organization, the plate portion 122′ is often ablation due to insufficient imbedding holding force. A standard testing force for twist and pulling used in the testing organization is 15 kg/F. However, the conventional one can only endure the twist and pulling force of about 10 kg/F. Therefore, the conventional SMA connector 1 has insufficient capability to endure the twist and pulling force, which might be damaged easily.

### SUMMARY OF THE INVENTION

The present invention is to provide an improved structure of coaxial cable connector.

It is the primary object of the present invention to provide an improved structure of coaxial cable connector which is composed of a T-shape connector and a ring sleeve body; and the characteristics include: an expansion portion of the T-shape connector being implemented with an around hindering ring and ring groove, with an expanded portion of the T-type connector provides a hollow space for fitting in front of the ring sleeve body, the ring groove bent inwardly with an angle of 90° in front of the end of hindering ring, and corresponding to a plate portion extending along a side, thereby allowing the ring groove to press inwardly by an angle of 90° for the plate portion to enclose the inner rim wall; wherein a ring hindering block is used to create an angle of 90° shape for the proper place of the inner rim of the ring sleeve body and a spacing groove organized between in the front end and in the hindering block ring of the ring sleeve body and the plate portion, wherein the ring hindering block is affixed to the T-shape connector through the ring sleeve body, whereby on the T-shape connector, the hindering ring can be clicked on the top of the rim as the expansion portion for creating some space between the spacing groove, the inner body of the ring sleeve, and the expanded portion of the T-shape connector; where the plate portion in the front of the end of the ring sleeve body is easily to be pressed in the ring groove of the T-shape connector, and when the connector is under the condition of twist and forces of pulling, a corner block on the top of the ring groove of the ring sleeve body is embedded and affixed into the indented corner on the bottom of the spacing groove ring, wherein the T-shape connector uses the hindering block ring of the structure with the angle of 90° at the inner rim of the ring sleeve body, and to firmly affix onto the hindering ring of the expansion portion on the T-shape connector, the plate portion in the front end of the ring sleeve body and encloses the ring groove of the T-type connector; which makes SMA connector endure larger twist and forces of pulling with firmer quality thereby enabling the T-shape connector and the ring sleeve body to be connected.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a cross-sectional view, schematically showing a conventional assembled product.

FIG. 2 is the section of divided perspective view, schematically showing a structure of connector, according to a preferred embodiment of the invention.

FIGS. 3-1 and 3-2 are a cross-sectional view, schematically showing the enclosing mechanism with the ring-pressing manner, according to the preferred embodiment of the invention.

FIG. 4 is a cross-sectional view, schematically showing an assembled product, according to the preferred embodiment of the invention.

### DETAILED DESCRIPTION OF THE PREFERRED EMBODIMENT

For the purpose of promoting an understanding of the principles of the invention, reference will now be made to the embodiment illustrated in the drawings. Specific language will be used to describe same. It will, nevertheless, be understood that no limitation of the scope of the invention is thereby intended, alterations and further modifications in the illustrated device, and further applications of the principles of the invention as illustrated herein being contemplated as would normally occur to one skilled in the art to which the invention relates.

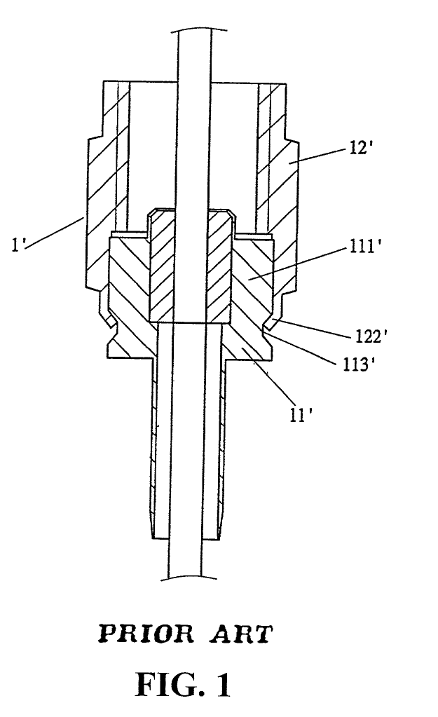

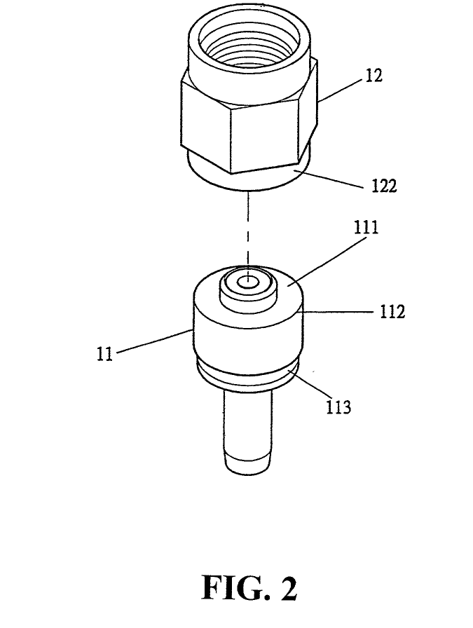

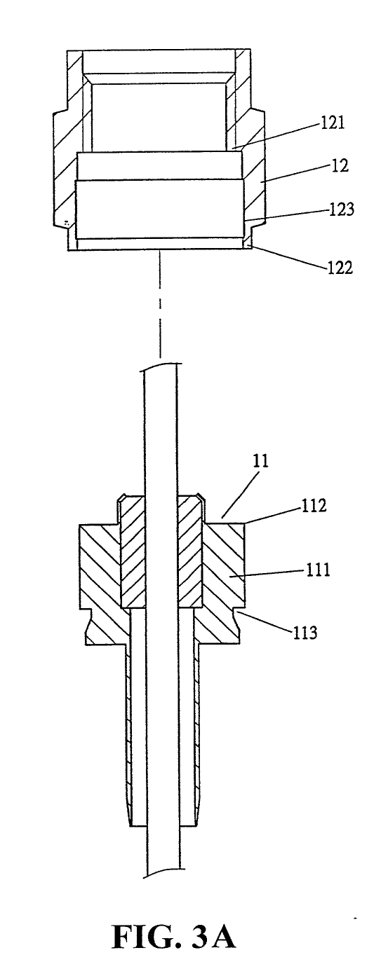

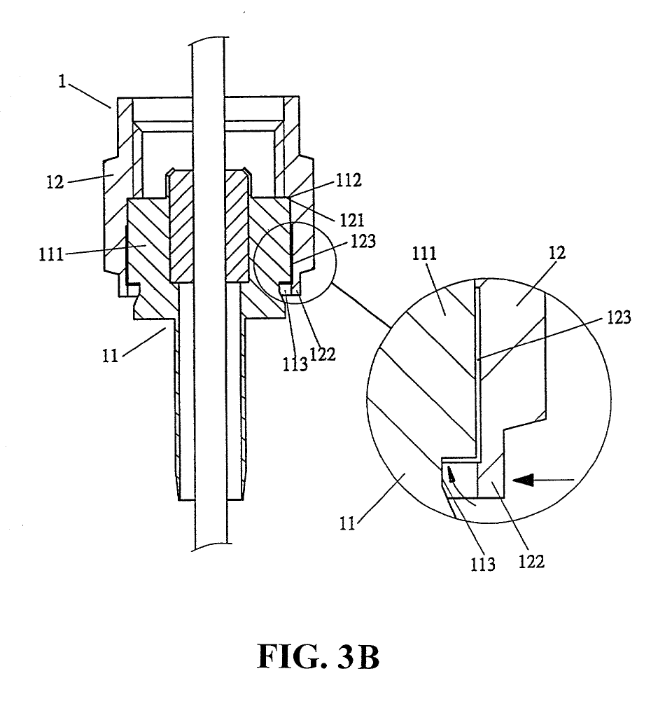

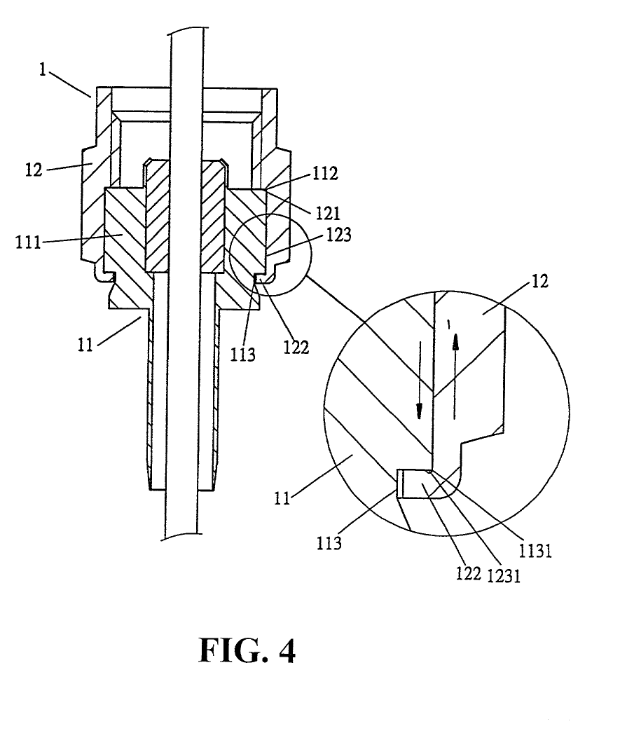

First, referring to FIGS. 2-4, the invention includes a T-type connector 11 with a ring sleeve body 12. On the one side of the T-type connector 11 is implemented with an expansion portion 111. A top of the expansion portion 11 has a hindering ring 112 and a ring groove 113. The size of the expansion portion 111 of the T-type connector can provide a ring sleeve body 12 with hollow inside to fit in. The ring groove 113 has indent with an angle of 90° at the front end of the hindering ring 112. The ring groove 113 with respect to a plate portion 122 extending along on side rim of the ring sleeve body 12 and the ring groove 113 can provide the plate portion 122 to inwardly press at an angle of 90°, so as to enclose and affix into the ring groove 113 at the top of inner rim. Moreover, the ring sleeve body 12 has a protruding ring hindering block 121 with a 90° right angle shape at the proper place, and a spacing groove 123 between the front end of the hindering block ring 121 of the ring sleeve body 12 and the plate portion 122. When the hindering block ring 121 on the ring body 12 affixes the T-type connector 11, the hindering structure with an angle of 90° to imbed and affix onto the hindering ring 112 at the top ring rim of the expansion portion 111 of the T-type connector 11. Moreover, a spacing is formed as the spacing groove 123 at the inner rim wall of the ring sleeve body 12 and the expansion portion 111 of the T-shape connector 11, whereby the plate portion 122 at the front end of the ring sleeve body 12 is easily to be pressed in the ring groove 113 of the T-type connector 11. When the SMA connector 1 endures the twist and pulling force, the top corner 1131 of the ring groove 113 of the ring sleeve body 12 is imbedded and affixed within the spacing groove 123 at the bottom indented corner 1231, whereby it has strong capability to imbed and affix, as shown in FIGS. 3-1, 3-2 and 4, wherein the T-type connector 11 uses the ring hindering block 121 with 90° shape at the inner rim of the ring sleeve body is imbedded and affixed on the hindering ring 112 of the expansion portion 111 of the T-type connector 11. Also, the plate portion 122 of the ring sleeve body 12 with the angle of 90° is enclosed on the ring groove 113 at the expansion portion 111 of the T-type connector 11. As a result, the SMA connector 1 can endure more twist and force of pulling with more affirming capability. According to foregoing subject matters, the invention further effectively improves the connection quality between the T-type connector and the ring sleeve body can be firmly affixed.

In summary, the invention indeed can be firmer than that of the conventional SMA connector. After a series of tests, it can endure 30 Kg/F of twist and force of pulling. Thus, we follow the patent laws and deliver the application for the patent.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An improvement of structure of coaxial cable connector (SMA), which is composed of a T-shape connector and a ring sleeve body; and the characteristics include: an expansion portion of the T-shape connector being implemented with an around hindering ring and ring groove, with an expanded portion of the T-type connector provides a hollow space for fitting in front of the ring sleeve body, the ring groove bent inwardly with an angle of 90° in front of the end of hindering ring, and corresponding to a plate portion extending along a side, thereby allowing the ring groove to press inwardly by an angle of 90° for the plate portion to enclose the inner rim wall; wherein a ring hindering block is used to create an angle of 90° shape for the proper place of the inner rim of the ring sleeve body and a spacing groove organized between in the front end and in the hindering block ring of the ring sleeve body and the plate portion, wherein the ring hindering block is affixed to the T-shape connector through the ring sleeve body, whereby on the T-shape connector, the hindering ring can be clicked on the top of the rim as the expansion portion for creating some space between the spacing groove, the inner body of the ring sleeve, and the expanded portion of the T-shape connector; where the plate portion in the front of the end of the ring sleeve body is easily to be pressed in the ring groove of the T-shape connector, and when the connector is under the condition of twist and forces of pulling, a corner block on the top of the ring groove of the ring sleeve body is embedded and affixed into the indented corner on the bottom of the spacing groove ring, wherein the T-shape connector uses the hindering block ring of the structure with the angle of 90° at the inner rim of the ring sleeve body, and to firmly affix onto the hindering ring of the expansion portion on the T-shape connector, the plate portion in the front end of the ring sleeve body and encloses the ring groove of the T-type connector, which makes SMA connector endure larger twist and forces of pulling with firmer quality thereby enabling the T-shape connector and the ring sleeve body to be connected.
